(19) United States
(12) Patent Application Publication
(10) Pub. No.: US 2012/0143763 A1
(43) Pub. Date: Jun. 7, 2012

(54) USING A FINANCIAL INSTITUTION BASED ACCOUNT FOR ULTRA-LOW LATENCY TRANSACTIONS

(76) Inventors: Alan Karp, Pato Alto, CA (US); Jun Li, Mountain ville, CA (US)

(21) Appl. No.: 13/384,761

(22) PCT Filed: Oct. 28, 2009
(86) PCT No.: PCT/US09/62342

§ 371 Date: Jan. 18, 2012

(51) Int. Cl. G06Q 40/00

(52) U.S. Cl. 705/44

(57) ABSTRACT

A system and method is illustrated for a reader to receive account data associated with an account managed by a financial institution, the account to be accessed to pay an amount associated with an ultra-low latency transaction. The system and method may also include a receiver to receive an instruction authorizing completion of the ultra-low latency transaction, the instruction generated based upon a comparison of the account data to an entry in a list that includes a plurality of account data. Additionally, the system and method may include a mechanism to allow completion of the ultra-low latency transaction.

### BACKGROUND

Special payment mechanisms have been developed for transactions that must be completed quickly, such as those that open the gates in a transit system. The traditional payment approach to achieve fast transactions relies on stored value cards on which financial data is stored. This financial data may relate to a monetary value remaining, where this monetary value may be used to pay for goods or services. These goods or services may include fares associated with a transit system. The monetary value associated with the stored value card can be identified using a storage element, which can be a microchip or a magnetic stripe embedded in the card, on which a card number and the remaining monetary value is encoded.

### BRIEF DESCRIPTION OF THE DRAWINGS

Some embodiments of the invention are described, by way of example, with respect to the following figures:

FIG. 1 is a diagram of a system, according to an example embodiment, used to register a device for use within a transit system.

FIG. 2 is a diagram of a system, according to an example embodiment, used to verify the account data (“D”) of a rider seeking to use a transit system.

FIG. 3 is a diagram of an alternative example embodiment in the form of a transit system that uses a verification gate and a local white list to validate “D.”

FIG. 4 is a diagram of an alternative example embodiment in the form of a transit system that uses a digital certificate stored in writable memory on a credit or debit card to validate “D.”

FIG. 5 is a diagram of an alternative example embodiment in the form of a transit system that utilizes a writable card that includes writing a digital certificate at a gate to a device for the purposes of verifying “D.”

FIG. 6 is a diagram of an alternative example embodiment in the form of a transit system that utilizes a writable card to place a hold on a portion of an account used to pay a fare for a rider of the transit system.

FIG. 7 is a diagram of a system, according to an example embodiment, that utilizes a writable card which includes a digital certificate and a hold placed on a portion of the account associated with this writeable card, to pay a fare for a rider of a transit system.

FIG. 8 is a diagram of an alternative example embodiment in the form of a transit system that utilizes a writable card having some computational capabilities.

FIG. 9 is a diagram of a system, according to an example embodiment, that is used to charge the account of a rider of a transit system.

FIG. 10 is a block diagram of an alternative example embodiment in the form of a system 1000 used to control access to a transit system using an entry and exit gate.

FIG. 11 is a block diagram of an alternative example embodiment in the form of a system used to control access to a transit system using an entry gate, a verification gate, and an exit gate.

FIG. 12 is a block diagram of an alternative example embodiment in the form of a gate used in a transit system.

FIG. 13 is a dual-stream flow chart illustrating an alternative example embodiment in the form of a method that regulates the usage of a transit system through comparing “D” against a white list.

FIG. 14 is a dual-stream flow chart illustrating an alternative example embodiment in the form of a method that regulates the usage of a transit system through comparing “D” against a white list that resides locally.

FIG. 15 is a dual-stream flow chart illustrating a method, according to an example embodiment, that uses a digital certificate in combination with writable memory on a credit or debit card to validate “D.”

FIG. 16 is a flowchart illustrating an alternative example embodiment in the form of a method showing the writing of a digital certificate to a device.

FIG. 17 is a dual-stream flow chart illustrating a method, according to an example embodiment, used to exit a transit system and to request payment for a fare through the use of a digital certificate written to a device.

FIG. 18 is a dual-stream flow chart illustrating an alternative example embodiment in the form of a method to place a hold on a portion of an account used to pay a fare for a rider of a transit system.

FIG. 19 is a flowchart illustrating an alternative example embodiment in the form of a method showing the writing of a digital certificate to a device used in accessing a gate.

FIG. 20 is a dual-stream flow chart illustrating an alternative example embodiment in the form of a method that utilizes the writable memory and computational capabilities of a device in combination with a nonce to access a transit system.

FIG. 21 is a dual-stream flow chart illustrating an alternative example embodiment in the form of a method that utilizes the writable memory and computational capabilities of a device in combination with a nonce to exit a transit system.

FIG. 22 is a diagram of an example computer system.

### DETAILED DESCRIPTION

Illustrated is a system and method for verifying credit and debit card data for use in an ultra-low latency transaction. This ultra-low latency transaction is a transaction for a good or service engaged in, for example, to pay for a subway ride, to pay for a movie in a multiplex movie theater, or to pay for parking at the parking lot that must be approved in less time than it takes to get verification from a financial institution. An example of ultra-low latency is less than one second. For the purpose of illustration only, ultra-low latency transactions relating to transit systems are discussed herein. Verifying, as used herein, includes a determination that the contents of a digital certificate are the same as when the digital certificate was originally signed. One example result of signing is that payment made with a credit or debit card will be honored by a financial institution. Factors used in determining that the payment will be honored include credit or debit card account numbers, digital certificates, digital signatures, a token, a public key, a private key, or other suitable values. One or more of these factors may be stored to writable memory on the credit or debit card. Example credit or debit card account data (i.e., “D”) includes at least one of a credit or debit card account number, account holder name, expiration data, or other data are associated with the credit or debit card to uniquely identify the account. A credit card, as used herein, is a physical card that has a line of credit associated with it that may be used in the purchase of goods or services. The line of credit is managed as an account by a financial institution. A debit card, as used herein, is a physical card that has a financial institution account associated with it that may be used to purchase goods or services. A financial institution may be a bank, credit union, or other suitable institution that manages an account into which monies are deposited. Like the credit card, a debit card number, account holder name, expiration date, or other data are associated with the debit card to uniquely identify the account. As used herein, a transit system is a publically accessible mode of transportation that charges a person (e.g., a rider) using the system a fare to use the system. Example transit systems include train systems, bus systems, and the other transportation modes.

In some example embodiments, the verification of the credit or debit card used by a rider to pay a transit system fare is facilitated through the use of one or more authorization techniques. An example authorization technique includes the pre-registration of the credit or debit card. In a transit application, a gate can be instructed to open only for approved, pre-registered credit or debit cards. A gate, as used herein, is a point of entry to, or exit from, a transit system or transportation mode that uses electronic factor based payment authorization. Example gates include an entry gate, verification gate, exit gate, transit gates, turnstile, fare gate, or other suitable devices. Opening a gate, as used herein, is to remove a physical barrier to access. In some example embodiments, a person, such as a bus driver, may serve as a gate by barring entry to those whose payment is not approved.

In some example embodiments, the dual-gate system utilizes a distributed system of gates (e.g., dual-gates) that are operatively connected to a station server. This station server may be operative connected to a transit server that is, in turn, operatively connected to a financial institution server. As used herein, operatively connected includes a logical or physical connection. In one example embodiment, the distributed system of gates is operatively connected to a station server or transit server via a physical or logic connection implemented as part of a network. Similarly, the transit server and financial institution server are logically or physically connected as part of a network. As used herein, the station server and transit server are servers controlled by a transit system authority, which may be a government organization (e.g., a government funded transit organization). As used herein, a financial institution server is a server controlled by a financial institution. An example of a financial institution server is a funds verifier server.

In some example embodiments, the system and method illustrated herein allows for verification of a rider's financial institution account data without having to contact the financial institution each time the rider enters the transit system. This system and method may be facilitated through a white list of pre-registered cards. A black list, in combination with a digital certificate written to the memory of a credit or debit card, may be used in lieu of a white list to verify the rider's financial institution account. Through the use of this system and method credit and debit cards may be used for ultra-low latency transactions, such as to enter and exit a transit system.

In some example embodiments, a digital certificate is written to the writeable memory of a credit or debit card. Example elements of a digital certificate include:
1. The unique identifier of the certificate;
2. The expiration time of the certificate;
3. A public key identifying the subject to which the certificate is issued. The subject can be a person (e.g., an account holder), a device, or a service.
4. A collection of assertions on the subject. Example can be “this card holder has the card number of 123456789,” “this card holder has set aside $20 for a ride,” “this holder has passed Gate #12 at Station #9 at time 9:00 am PST.”
5. A digital certificate that is produced by having the entire document (excluding the digital certificate field itself) signed by the private key of the party that issue this certificate. This private key is owned and can be only accessed by the party that issues the certificate.
   Optionally, a digital certificate (e.g., “A”) can encapsulate another certificate (e.g., “B”) as the evidence for another digital certificate (e.g., “C”) to be issued. An example can be found by “A₁”=s(T, A₀+S), in which “A₀” is the certificate encapsulated by “A₁,” as an evidence for a transit server “T” to issue “A₁” to the card holder. “S” is one of the assertions in A₁, such as “the rider just passed the Gate S.” In some example embodiments, a digital certificate can be produced by following the Security Assertion Markup Language (SAML) standard. One or more of the above elements can be used in verifying that “D” is valid. For example, the expiration date of the digital certificate may be verified, or the appropriateness of the use of the digital certificate may be verified.

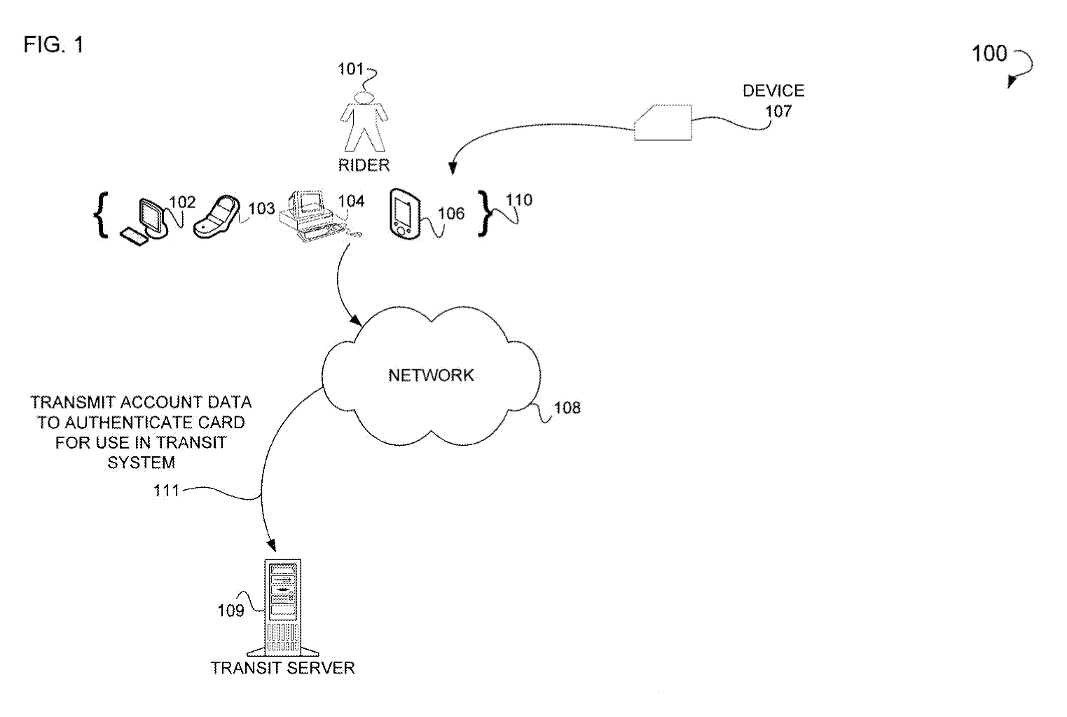

FIG. 1 is a diagram of an example system 100 used to register a device for use within a transit system. Illustrated is a rider 101 who uses one or more of the devices 110 to register account data of a credit or debit card for use in ultra-low latency transactions within a transit system. The devices 110 include a kiosk 102, cell phone 103, computer system 104, or smart phone 106. A kiosk 102, as used herein, is a highly customized computer terminal that allows for the registration of a credit or debit card account data (i.e., “D”) for the purpose of using an ultra-low latency transaction. Highly customized, as used herein, means capable of limited functions such as running a single computer program. As used herein, we will use “D” to denote the account data plus any additional information used for account verification. Registration is illustrated at 111, wherein “D” is transmitted by one or more of the devices 110 across a network 108 to a transit server 109. When verified by the transit server 109, “D” is authorized for use in ultra-low latency transactions in the transit system's servers.

In some example embodiments, the account data “D,” associated with a device 107, is registered for use in ultra-low latency transactions within a transit system. Information in addition to “D” that may be registered includes the account holder name, expiration date of the credit or debit card and other suitable information. The device 107 may be a credit or debit card with a magnetic stripe, or a Radio Frequency Identifier (RFID). The device 107 may also be a Near Field Communications (NFC) enabled device. Additionally, in some example embodiments, the device 107 has an embedded smart card chip. The smart card chip has a processor to carry out general computation. Further, it can be equipped with a crypto co-processor that can carry out the Public Key Cryptography (PKC). With the supported public key cryptographical computation capability, the device 107 can: (1) verify the digital signature of the digital certificate that it receives, and (2) produce a new certificate by using the private key of the public/private key pair associated with the device.

In one example embodiment, using a card reader, in association with one or more of the devices 110, “D” is read from a device 107 and transmitted across a network 108 to be received by the transit server 109. Example card readers include the UNITECH MSR206™, CHERRY ST-1044 U SMART CARD READER/WRITER™, CHERRY ST-1000 SMART CARD READER/WRITER™, IDTECH EZWRITER CARD READER-WRITER™, or the IDTECH 3840 STRIPE READER-WRITER™. The network 108 may be an internet, Local Area Network (LAN), or Wide Area Network (WAN), and may use protocols including one of the 802.11 standards, the Code Divisional Multiple Access (CDMA) standard, the Global System for Mobile (GSM) communication standard, or other protocols used in association with the various layers of the Open System Interconnection (OSI) reference model. Further, the network 108 may employ various encryption regimes including Hyper Text Transfer Protocol Secured (HTTPS), WiFi-Protected Access (WPA), and Wired Equivalent Privacy (WEP). Registration includes verifying that “D” is valid, and is not currently on a black list. Once “D” is registered with the transit server 109, “D” may be added to a white list that is distributed to gates within the transit system. A white list, as used herein, is a list or register of “D” values associated with credit or debit accounts, where the people using these cards are provided a particular privilege or service, such as access to the transit system. In contrast, a black list, as used herein, is a list or register that identifies “D” values associated with accounts that are to be denied the privilege or service, such as access to the transit system. This black list may also be distributed to the gates within the transit system when used in conjunction with a digital certificate. Black lists are used so that merchants (e.g., the transit system) can refuse cards reported lost, stolen or those associated with closed accounts. In some example embodiments, valid “D” values are stored in a white list, while invalid “D” values are stored in a black list.

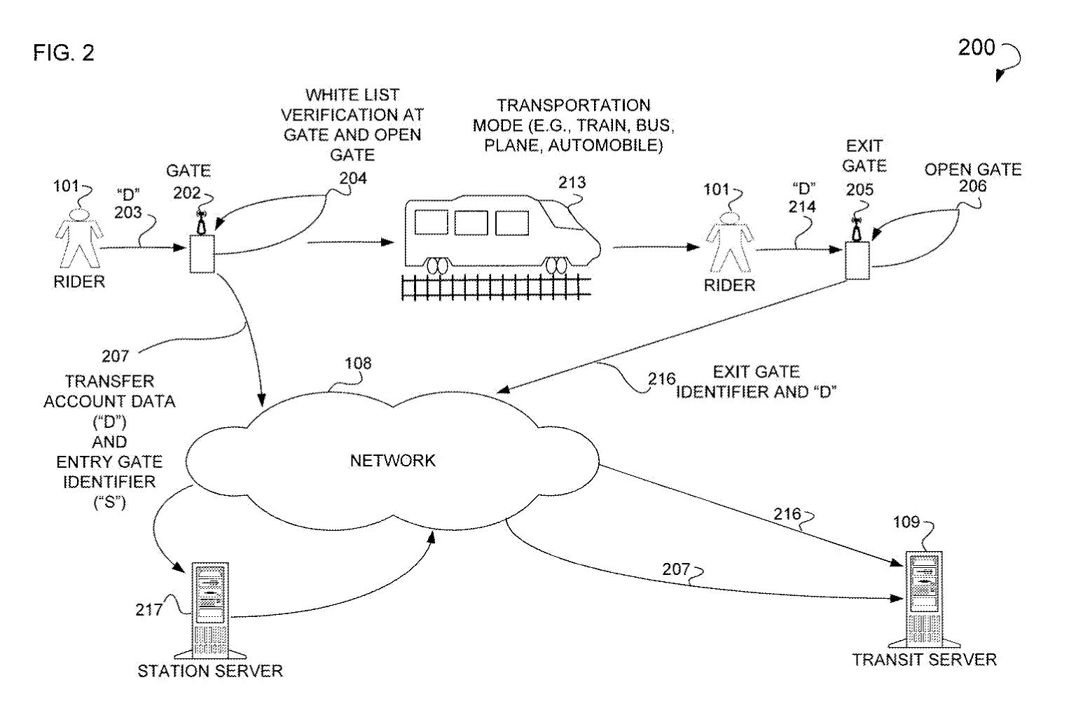

FIG. 2 is a diagram of an example system 200 used to verify the “D” of a rider seeking to use a transit system. As illustrated above in FIG. 1, “D” is registered with a transit system. Once registered, rider 101 is able to access the transit system using the following protocol:
1. Rider 101 uses the credit or debit card (not pictured) to transfer “D” to a gate 202. Gate 202 is an entry gate into the transit system. This transfer is referenced at 203.
2. As referenced at 204, gate 202 verifies that “D” is on a white list and opens to allow the rider 101 access to the transportation mode 213. This white list may reside natively on the gate 202, or may be located remotely on the station server 217. In order to reduce the verification time, the gate 204 may communicate with the station server 217, which holds the white list of pre-registered accounts (see FIG. 1) distributed by the transit server 109. In some example embodiments, the gate 202 may seek to verify “D” using the transit server 109. The transportation mode, as used herein, is a system of transportation example of which include train, plane, bus, automobile, or other forms of transportation.
3. Further, as referenced at 207, at some later time, gate 202 sends “D” and the gate identifier “S” to the transit server 109, referenced herein as “T.” “S,” as used herein, is a numeric value used to uniquely identify gate 202 or the station server 217. In some example embodiments, “D” and the gate identifier “S” are sent directly by the gate 202 to the transit server 109, bypassing the station server 217.
   After using the transit mode 213, in some example embodiments, the rider 101 exits the transit system using the following protocol:
4. Rider 101 uses the credit or debit card (not pictured) to transfer “D” to the exit gate 205. This transfer is referenced at 214. This transfer process is facilitated using a card reader associated with the gate 205.
5. Exit gate 205 opens, as referenced at 206.
6. As referenced at 216, at a later time, exit gate 205 sends “D” and an exit gate identifier “S₁” to “T.” “T” matches the entry and exit gates, computes the fare, and sends a payment request to a funds verifier server (not pictured) referenced herein as “B.” In some embodiments, the exit gate 205 may send “S₁” and “D” via the station server 217 for forwarding to the transit server 109.
   As illustrated, a wireless connection may exist between the gates 202 and 205, and the station computer 217 and transit server 109. Specifically, as previously stated, the network 108 may use protocols including one of the 802.11 standards, the CDMA standard, or the GSM communication standard.

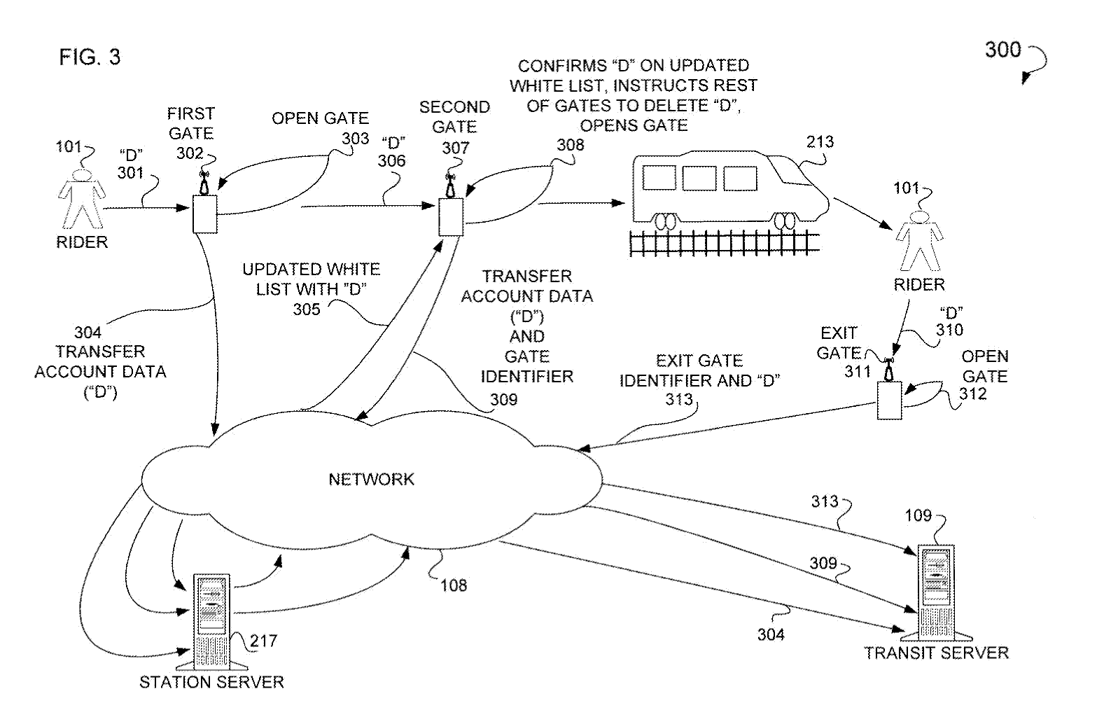

FIG. 3 is a diagram of an alternative example embodiment in the form of a transit system 300 that uses a verification gate and a local white list to validate “D.” Shown is the rider 101, who enters the transit system 300 via a first gate 302. The rider 101 is able to access the transit system using the following protocol:
1. As referenced at 301, rider 101 uses a credit or debit card (not pictured) to transfer “D” to the first gate 302. This transfer may be via a reader (e.g., a card reader) associated with the first gate 302 that reads a magnetic strip on the debit or credit card, or an embedded RFID tag associated with a device (e.g., a credit or debit card), or an NFC-enabled device.
2. The first gate 302 opens, as referenced at 303, so rider 101 can access a second gate 307. The second gate 307 is a verification gate.
3. As referenced at 304, the first gate 302 sends “D” to station server 217 to be used to generate an updated white list. In some embodiments, gate 302 may send “D” to “T” 109.
4. Station server 217 (or “T” 109) sends “D” and the amount of the most expensive fare to the financial institution “B” (not shown) for a confirmation number, as with a normal credit or debit transaction.
5. When station server 217 (or “T” 109) receives the confirmation number, it adds “D” to the white list and distributes it to the second gates 307 in the station.
   Gate 307 gets an updated white list from the station server (or “T”), as referenced at 305. This updated white list may be distributed to all verification gates (e.g., gate 307) in the same station as gate 302. The updated white list may be a data structure that includes all valid “D” values for credit or debits card accounts used by riders positioned between any of the first gates 302 in a station and any of the second gates 307 in the same station. Example data structures include arrays, hash tables, binary-search trees, red-black tree, or some other suitable data structure. The protocol of system 300 further includes:
6. As referenced at 306, rider 101 using a device 107 (not pictured) to transfer “D” to gate 307.
7. If “D” is on the updated white list, then gate 307 opens, as referenced at 308. Gate 307 further instructs other gates in the station 300 to delete “D” from the updated white list. The rider 101 is able to pass through the gate 307 and access the transportation mode 213.
8. At a later time, as referenced at 309, gate 307 transmits “D” and the station/gate identifier “S” to “T.” “S,” as used herein, is a numeric value used to uniquely identify gate 307 or the station 300.
9. As referenced at 310, when attempting to exit the transportation mode 213, the rider 101 in some embodiments provides “D” to an exit gate 311. Exit gate 311 opens, as referenced at 312, and the rider 101 exits the transit system. At some later time, as referenced at 313, the exit gate 311 provides an exit gate identifier “S₁” and “D” value to “T” for the purpose of computing a fare to charge against the credit or debit card account associated with “D.” This fare is provided to “B” as part of a payment request. In some embodiments, the exit gate 311 may send “S₁” and “D” via the station server 217 for forwarding to the transit server 109.

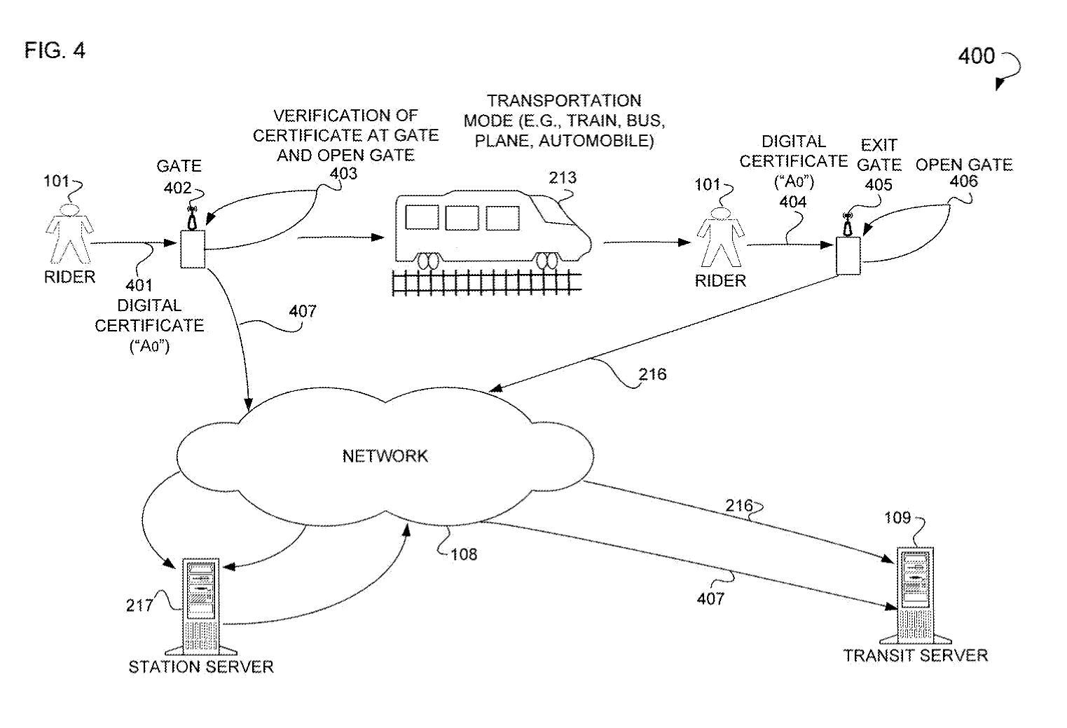

FIG. 4 is a diagram of an alternative example embodiment in the form of a transit system 400 that uses a digital certificate stored in writable memory on a credit or debit card to validate an account data “D.” In some example embodiments, a digital certificate in the form of “A₀” is written to the device 107. A digital certificate can be encoded in a format such as SAML. “A₀” is issued by a financial institution (e.g., “B”) to the credit or debit card holder. The financial institution signs “A₀” as part of the digital certificate generation process to denote that it guarantees payment of the most expensive permitted ultra-low latency transaction, such as a train ride. Applied in the system 400, a protocol is implemented such that:
1. As referenced at 401, rider 101 uses a device (not pictured) to transfer “A₀” to gate 402, and a card reader associated therewith.
2. Gate 402 verifies “A₀” and opens as referenced at 403. Verification may take the form of gate 402 using a public key of the financial institution “B” that resides on the gate 402. If “A₀” is valid, rider 101 is allowed to access the transportation mode 213.
3. As referenced at 407, at a later time, gate 402 sends “A₀” and the gate identifier “S” to “T.” “D” may also be included in this information.
4. Optionally, “T” may submit “D” to “B” to receive confirmation verification. If “B” denies the request, “B” can add “D” to a black list distributed to gates (e.g., entry gate 402 and exit gate 405) within the system 400 by “T.”
5. As rider 101 exits the transportation mode 213 and approaches the exit gate 405, rider 101 provides “A₀” to the exit gate 405. This providing of “A₀” to the exit gate 405 is referenced at 404.
6. Exit gate 405 verifies that “A₀” has not been forged and “D” is not on a black list.
7. Exit gate 405 opens, as referenced at 406.
8. As referenced at 216, in some embodiments at some later time, exit gate 405 transfers “D” and gate identifier “S₁” to the “T.” The data provided to “T” at 216 and 407 is used to compute a fare to charge against the credit or debit card account associated with “D.” This fare is provided to “B” as part of a payment request. In some embodiments, the exit gate 405 may send “S₁” and “D” via the station server 217 for forwarding to the transit server 109.
   In some example embodiments, the transit server 109 generates the digital certificate in the form of “A₀”, or “A₁”-“A₆” referenced below. For example, “D” is provided to a function residing on the transit server 109 that uses “D” in combination with other numeric values to generate a digital certificate, token, or other suitable numeric values used for verification of the credit or debit card account number. The digital certificate “A₀” is written to the device 107 using a card writer. Specifically, storage of “A₀” may be facilitated through the use of read/write device that can write “A₀” to a magnetic stripe on the device 107.

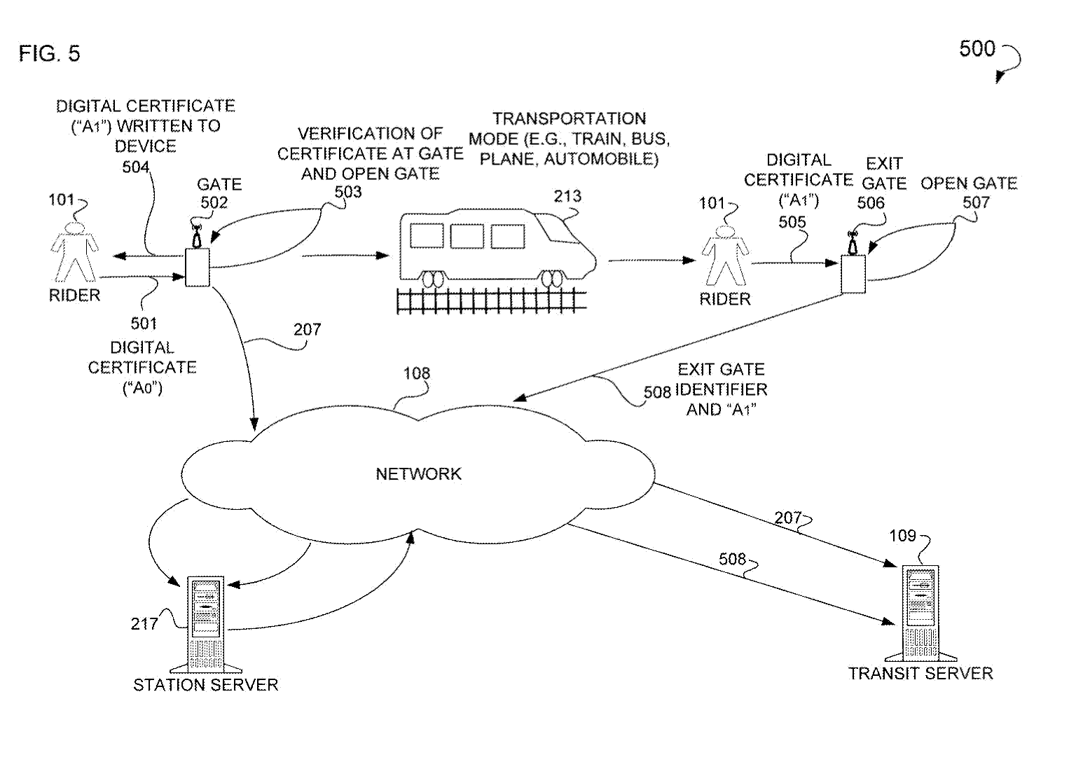

FIG. 5 is a diagram of an alternative example embodiment in the form of a system 500 that utilizes a writable card that includes writing a digital certificate at a gate to a device for the purposes of communicating “D” or other information to other gates in the transit system. Applied in the system 500, “A₀” is used as part of a protocol is implemented such that:
1. As referenced at 501, rider 101 uses a device 107 (not pictured) to transfer “A₀” to the gate 502. This transfer is facilitated through the use of a card reader associated with the gate 502.
2. Gate 502 verifies that “A₀” is valid, which means that it is properly signed and that “D” is not on the revoked list (e.g., a black list).
3. As referenced at 504, gate 502 writes “A₁”=s(T, A₀+S) to the device 107, where “T” is an identifier of a transit server and “S” identifies gate 502. “A₁” is the digital certificate signed by the transit server identified by “T” and “A₁” encapsulates “A₀” as a part of the evidence to support “A₁'s” validity. Here “A₁” states that the holder of “A₀” has entered at station “S” (i.e., an entry gate such as gate 502). Optionally, gate 502 may transmit “A₁” to “T,” and ultimately to “B,” as referenced at 207.
4. Gate 502 opens as referenced at 503, and rider 101 is free to access the transportation mode 213.
5. As referenced at 505, rider 101 uses the device 107 (not pictured) to transfer “A₁” to the exit gate 506.
6. Exit gate 506 verifies that “A₁” is valid, and opens the exit gate 506, as referenced at 507.
7. At a later time, exit gate 506 delivers “A₁” and “S₁” to “T.” This delivery is referenced at 508. In some embodiments, the exit gate 506 may send “S₁” and “D” via the station server 217 for forwarding to the transit server 109.
   At some later time, as referenced at 508 and 207, in some embodiments “T” computes the fare for rider 101 by matching the record from exit gate 506 against the entry station “S” recorded in “A₁,” and submits a payment request to “B.”

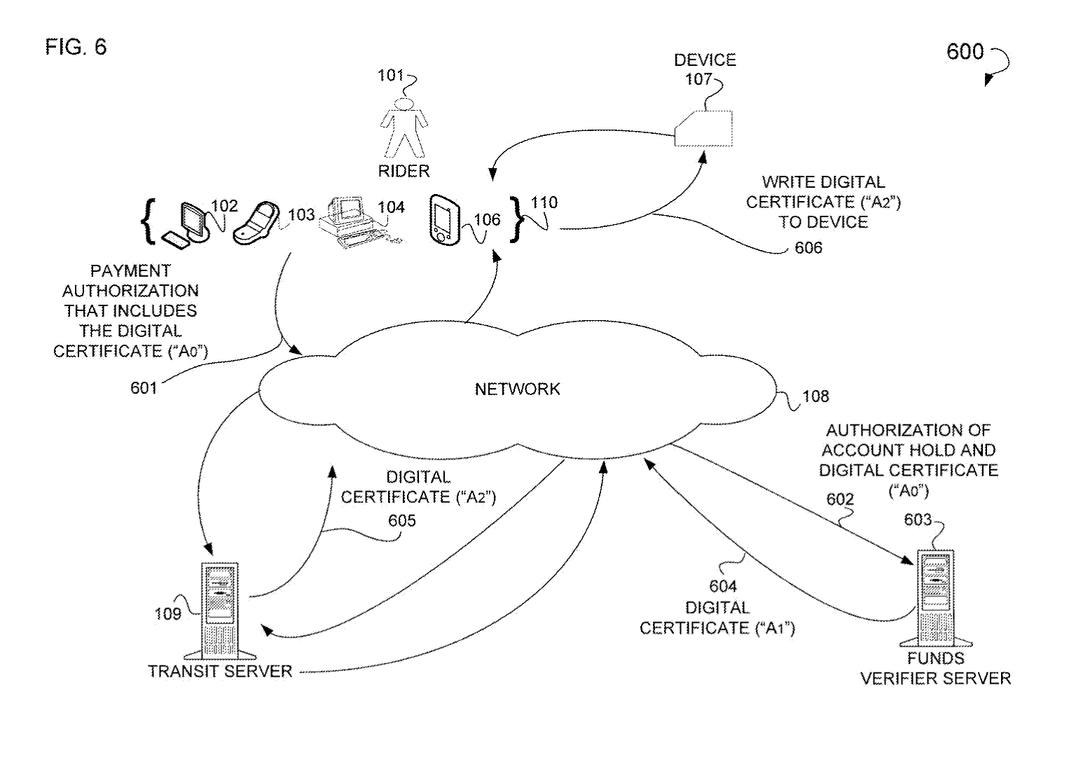

FIG. 6 is a diagram of an alternative example embodiment in the form of a system 600 that utilizes a writable card to place a hold on a portion of an account used to pay a fare for a rider of a transit system. In some example embodiments, a digital certificate (e.g., “A₀”), signed by “B,” is written to the writeable credit or debit card. This digital certificate is written to a credit or debit card after a hold is placed on the credit line or deposit account associated with “D.” This hold is for a specified amount. For example, according to one protocol:
1. As referenced at 601, rider 101 delivers to “T” a payment authorization that includes “A₀,” via one or more of the devices 110. “A₀” may be initially stored on the device 107 before the device is registered with “T.” In response to receiving the payment authorization, as referenced at 601, the transit server “T” transmits to a funds verifier server 603 (i.e., “B”) a request for a reduction of the credit limit or withdrawal from a debit account relating to rider 101's account with “B.” This charge or withdrawal is based upon the amount for a ride offered by the transportation mode 213 associated with “T.” Optionally, an expiration date can be include in “A₀.”
2. As referenced at 602, “T” submits “A₀” to the funds verifier server 603 to request that a hold for a designated amount be placed on rider 101's account. This designated amount is a monetary amount used to cover one or more fares associated with utilizing the transportation mode 213.
3. As referenced at 604, “B” establishes the hold and returns “A₁”=s(B, A₀) to “T”. “A₁” is a digital certificate that is issued to “T” by “B,” to denote that “B” is guaranteeing the amount specified in the hold. “B” is an identifier used to uniquely identify the funds verifier server 603. Optionally, an expiration date can be included in “A₁.”
4. As referenced at 605, “T” creates a signed “A₂”=(T, A₁) that is provided to one or more of the devices 110 used in the registration process. (See FIG. 1) “A₂” is a digital certificate which states that the account referenced in the digital certificate “A₀” is registered in the transit system. “T” is an identifier used to uniquely identify the transit server 109. Optionally, an expiration date can be included in “A₂.”
5. As referenced at 606, “A₂” is transferred to the device 107. This writing may be performed using a card writer/encoder associated with one or more of the devices 110.

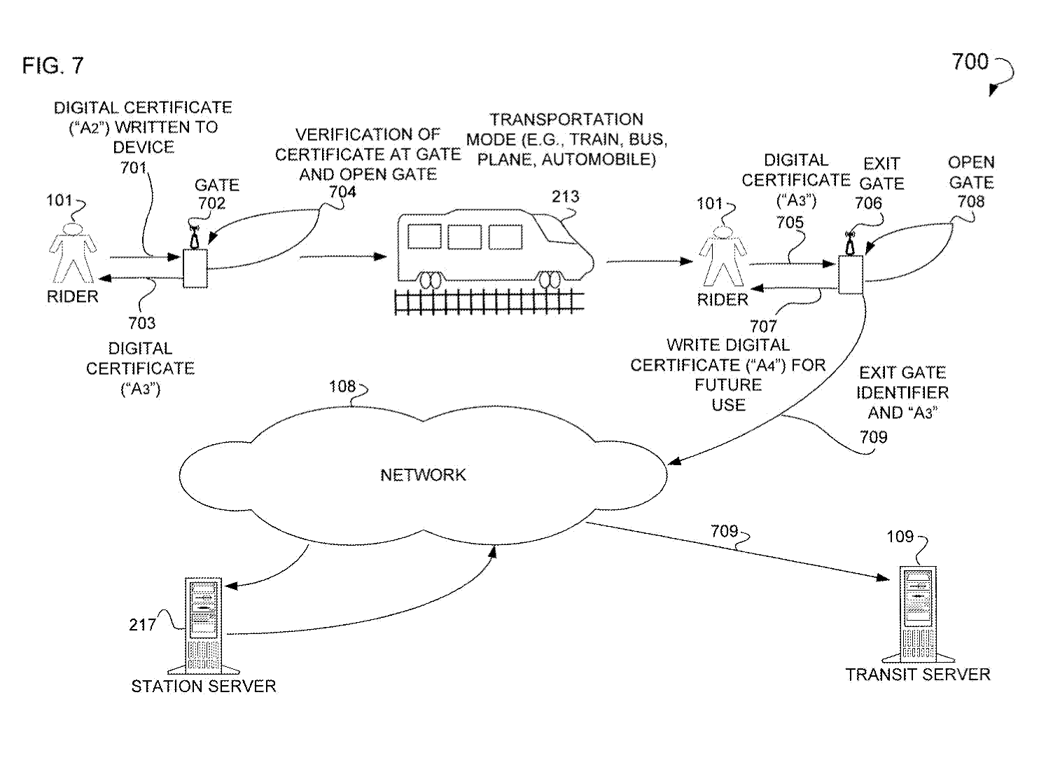

FIG. 7 is a diagram of an example system 700 that utilizes a writable card which includes a digital certificate, and a hold placed on an account associated with this writeable device, to pay a fare for a rider of a transit system. This fare is paid via a hold amount placed on a credit or debit card account. In one example embodiment, a protocol that utilizes a hold may be used such that:
1. Rider 101 uses a device to transfer “A₂” to gate 702. This transfer is referenced at 701. Transfer is facilitated via a card reader associated with the gate 702.
2. As referenced at 704, gate 702 verifies that “A₂” is a valid digital certificate.
3. As referenced at 703, gate 702 attaches the entry gate identifier “S” to “A₂” and a transaction identifier “M,” and returns the signed result “A₃”=s(T, A₂+S+M) to a device. Optionally, a time stamp may be included in “A₃.” The gate 702 opens. Rider 101 proceeds to the transportation mode 213.
4. As referenced at 705, rider 101 provides “A₃” to the exit gate 706. After the exit gate 706 verifies that “A₃” is valid, exit gate 706 attaches an identifier for “T” to the “A₁” value to generate “A₄”=s(T, A₁). “A₄” is a digital certificate, similar to “A₂” that states the card specified in the enclosed “A₀” has been registered with the transit system.
5. As referenced at 707, after the exit gate 706 verifies that “A₃” is valid, “A₄” is written to a device to replace “A₂” for a future ride.
6. If “A₃” is valid, exit gate 706 opens, as referenced at 708.
7. As referenced at 709, at a later time exit gate 706 may submit “A₃” along with the exit gate identifier “S₁” to “T.” In some embodiments, “T” computes the fare by using “S₁” (the exit gate) and the “S” (i.e., the entry gate) recorded in “A₃,” and submits “A₃” to “B” a payment request including the computed fare. “A₃” and “S₁” may be submitted to the station server 217, and forwarded to “T.” In the alternative, “A₃” and “S₁” may be directly submitted to “T.”
8. “B” processes the payment request, credits “T,” and marks “A₃” as used by recording “M.” Further, “B” releases the hold on the difference between the fare and the amount authorized in “A₀.” (See FIG. 6.) “B” establishes a new hold on rider 101's account for the most expensive ride.

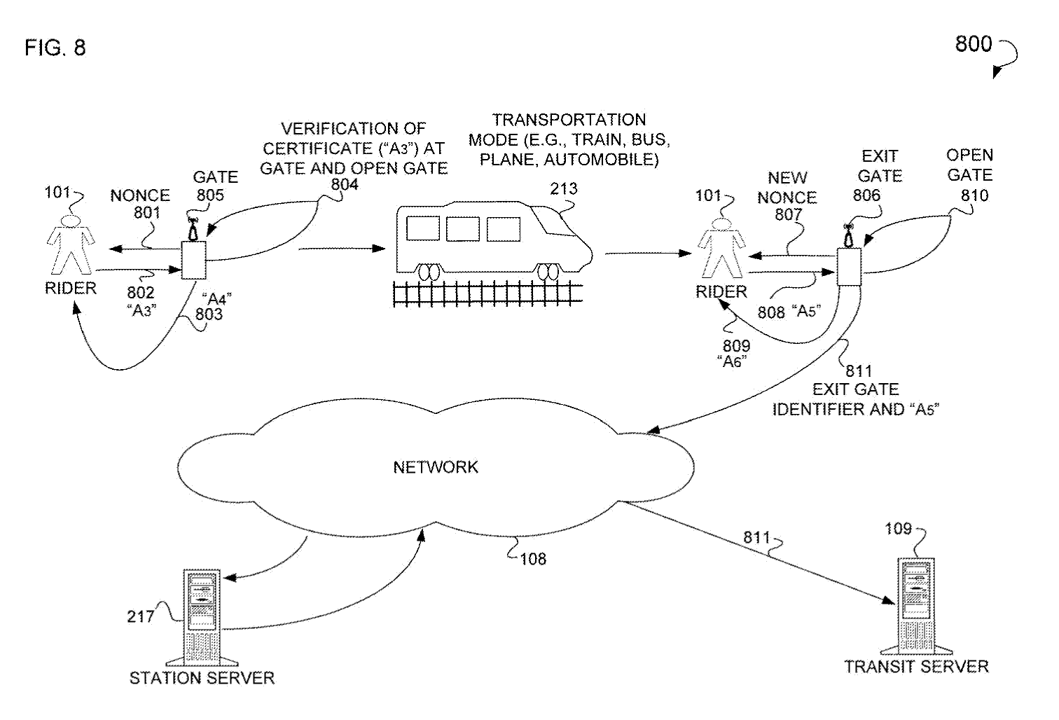

FIG. 8 is a diagram of an alternative example embodiment in the form of a system 800 that utilizes a writable card having some computation capability. As used herein, a nonce is a number that is used once for authentication purposes. The nonce may serve the purpose of verifying that the device 107 (e.g., the credit or debit card) used by the rider 101 is authentic, and issued by the funds verifier server (i.e., “B”). Specifically, through verifying the device 107, it can be determined that the device 107 is not, for example, an illegitimate card fabricated through a card cloning process or that it carries a digital certificate copied from another card. The protocol for system 800 may include:
1. Gate 805 delivers a nonce “n” to a device 107 as referenced at 801. Delivery may be via a card writer/encoder associated with the entry gate 805.
2. The device 107 produces “A₃”=s(N, A₂+n) and transfers “A₃,” as referenced at 802, to entry gate 805. “A₃” is a digital certificate issued by the device that encapsulate “A₂” and include the received “n.” Transfer is facilitated via a card reader associated with the entry gate 805.
3. Entry gate 805 verifies that “A₃” is valid, by determining that “A₃” corresponds to the public key in “A₀.”
4. Entry gate 805 attaches the entry gate identifier “S” to “A₃” and a unique transaction identifier “M,” and returns the signed result “A₄”=s(T, A₃+M+S) to the device. “A₄” is a digital certificate issued by the gate computer that encapsulate “A₃” and contain the numbers “M” and “S.” As referenced at 803, “A₄” is transferred and written to the device 107. Optionally, a time stamp may be included in “A₄.” “S” may be a numeric value to uniquely identify entry gate 805.
5. The entry gate 805 opens, as referenced at 804, and rider 101 proceeds to the transportation mode 213.
   The verification of “A₃” by the entry gate 805 may include the entry gate 805 transmitting “A₃” to the station server 217 for verification using a black list. As illustrated below, the protocol of system 800 may also include:
6. Rider 101 using a device 107 to communicate with the exit gate 806.
7. As referenced at 807, exit gate 806 delivers a new nonce “n1” and a gate ID to a device 107. The gate ID is a numeric value used to uniquely identify the exit gate 806.
8. As referenced at 808, the device calculates “A₅” and transfers “A₅”=s(N, A₄+n1) to exit gate 806. “A₅” is a digital certificate that is issued by the device and encapsulates “A₄” and includes “n1.”
9. As referenced at 809, after verifying that “A₅” is valid, exit gate 806 delivers “A₆”=s(T, A₁) to a device. “A₆” is a digital certificate issued by the exit gate on behalf of the transit authority to state that card has been registered with the transit system and is the same card as specified in “A₀.” “A₆” may be used because of the optional expiration time on “A₄.”
10. As referenced at 810, after exit gate 806 verifies that “A₅” is valid and is sufficient to cover the cost of the actual ride, exit gate 806 opens.
11. As referenced at 811, at some later point, a payment process is initiated. Specifically, as referenced at 811, gate 806 submits “A₅” and the exit gate ID (e.g., “S₁”) to the station server 217. In some example embodiments, “A₅” and the exit gate ID are submitted to “T” directly.
12. In some embodiments, “T” computes the actual fare based on “S₁” (i.e., the exit gate) and “S” (i.e., the entry gate) recorded in “A₄” (i.e., encapsulated in “A₅”), and submits “A₅” to “B” for payment of the amount of the fare. “B” processes the payment, credits “T,” or account maintained for “T” by “B.” “B” marks “A₅” as used by associating “A₅” with “M.” The funds verifier server 212 establishes a hold on rider 101's account for the most expensive ride.

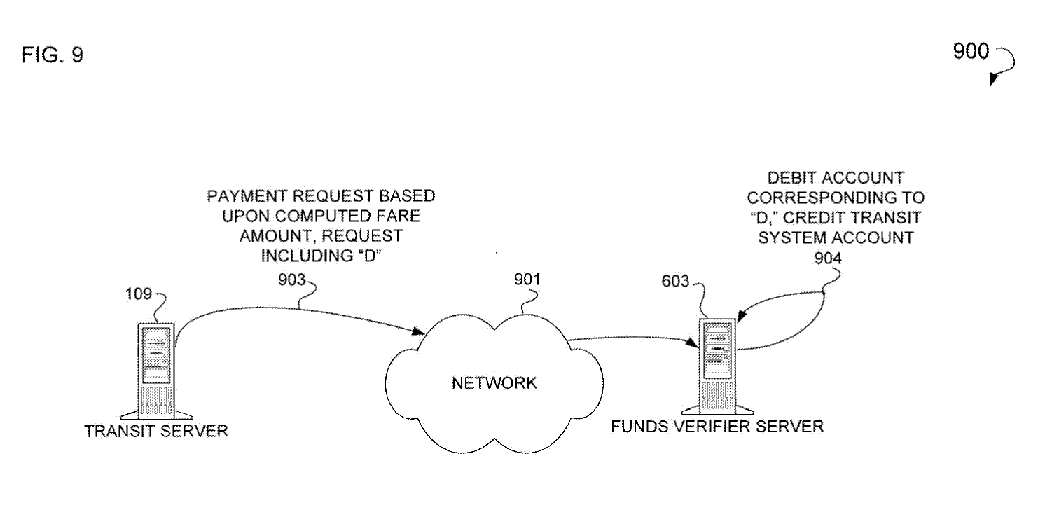

FIG. 9 is a diagram of an example system 900 that is used to charge the account of a rider of a transit system. Shown is the transit server 109 operatively connected to the funds verifier server 603 via a network 901. The network 901 may be an internet, LAN, WAN, or protocols used in association with the various layers of the OSI reference model. As referenced at 903, the transit server 109 may generate a request for payment and transmit this request for payment across the network 901 to be received by the funds verifier server 603. Included in this request for payment, may be a fare amount including a “D” value to identify a credit or debit card account. The funds verifier server 904 receives this request for payment and debits the credit or debit card account corresponding to “D” for an amount specified in the fare. The funds debited from the credit or debit card account are applied to an account owned by the transit system. In some example embodiments, “B” may charge a transaction fee processing the request for payment.

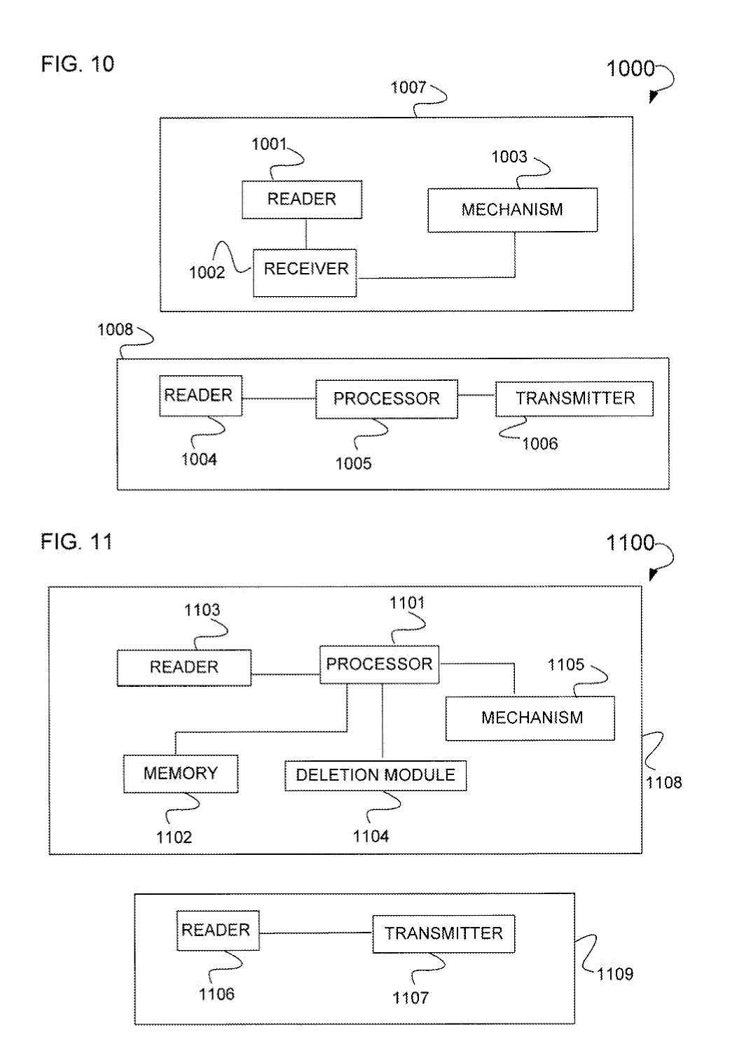

FIG. 10 is a block diagram of an alternative example embodiment in the form of a system 1000 used to control access to a transit system using an entry and an exit gate. These various blocks may be implemented in hardware, firmware, or software as part of the gate 202. Further, these various blocks are logically or physically connected. Shown is a reader 1001 operatively connected to a receiver 1002. The reader 1001 is utilized to receive account data associated with an account managed by a financial institution, the account to be accessed to pay an amount associated with an ultra-low latency transaction. Also shown is a receiver 1002 to receive an instruction authorizing completion of the ultra-low latency transaction, the instruction generated based upon a comparison of the account data to an entry in a list that includes a plurality of account data. Operatively connected to the receiver 1002 is a mechanism 1003 to allow completion of the ultra-low latency transaction. This mechanism 1003 may be a device to remove a physical barrier to allow entry a transit system, unlocking a door, or delivering an item such as a ticket. In some example embodiments, the reader is at least one of a magnetic stripe reader, an RFID tag reader, or a reader that is capable of reading microchip storage on a portable device. In some example embodiments, the account data includes at least one of a credit card account number, a debit card account number, an account holder name associated with an account number, or an expiration date associated with an account number. In some example embodiments, the account data is registered with the system before it is received by the reader. Also shown is an additional reader 1004 to receive the account data associated with the account managed by the financial institution. Operatively connected to the additional reader 1004 is a processor 1005 to compare the account data to the entry in the list that includes the plurality of account information. Operatively connected to the processor 1005 is a transmitter 1006 to transmit the account data and an identifier, the identifier to identify a mechanism used to complete the ultra-low latency transaction. This mechanism may be a gate, a device to remove a physical barrier to allow entry a transit system, an unlocking a door, or delivering an item such as a ticket. In some example embodiments, the reader, the receiver, and the entry mechanism reside on an entry gate 1007 of a transit system, and the additional reader, the processor, and the transmitter reside on an exit gate 1008 of the transit system. In some example embodiments, entry gate 1007 and exit gate 1008 are operatively connected via the network 108 to the transit server 109, or station server 217.

FIG. 11 is a block diagram of an alternative example embodiment in the form of a system 1100 used to control access to a transit system using an entry gate, verification gate, and exit gate. This diagram also is an example of a station server. These various blocks may be implemented in hardware, firmware, or software. Further, these various blocks are logically or physically connected. Shown is a processor 1101 and a memory 1102 operatively connected to the processor 1101. Memory 1102 may be persistent or non-persistent memory. Operatively connected to the processor 1101 is a reader 1103 to receive account data associated with an account managed by a financial institution, the account to be accessed to pay a fare associated with an ultra-low latency transaction. In some example embodiments, the processor 1101 is used to compare the account data to an entry in a list that includes account data. Operatively connected to the processor 1101 is a deletion module 1104 to delete an entry in the list, the entry deleted based upon the comparison of the account data to the entry in the list that includes account data. Operatively connected to the processor 1101 is a mechanism 1105 to authorize completion of the ultra-low latency transaction based upon the comparison of the account data and the entry in the list. This mechanism may be a gate, a device to remove a physical barrier to entering a transit system. The system 1100 also includes an additional reader 1106 to receive the account data associated with the account managed by the financial institution. A transmitter 1107 is operatively connected to the additional reader 1106 to transmit the account data and an identifier, the identifier to identify an exit mechanism used complete the ultra-low latency transaction. This exit mechanism may be a gate, a device to remove a physical barrier to exiting a transit system. In some example embodiments, the reader 1103, the processor 1101, and mechanism 1105 reside on a first gate 1108, and the additional reader 1106, the deletion module 1104 and the transmitter 1107 reside on a verification gate 1109. In some example embodiments, the gates 1108 and 1109 are operatively connected via the network 108 to a transit server 109, or station server 217.

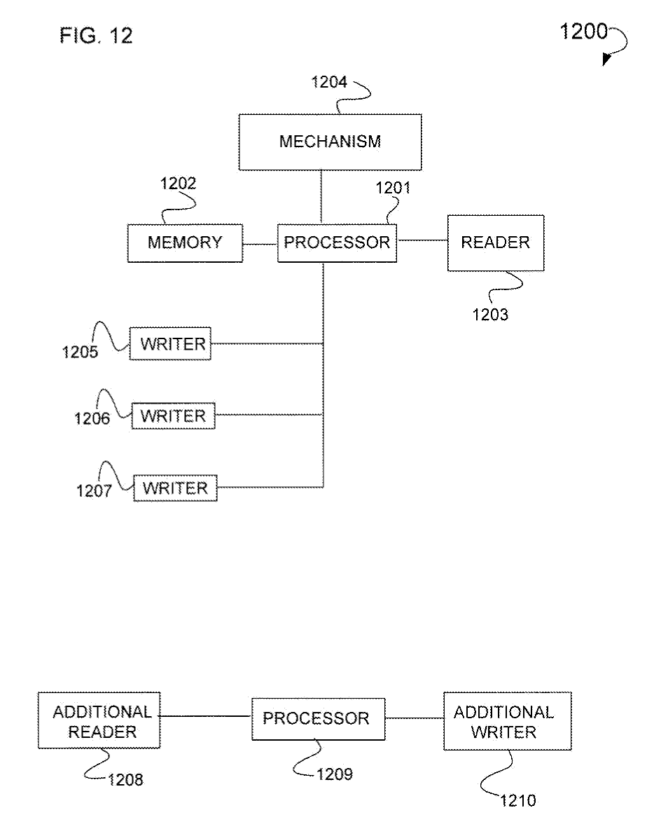

FIG. 12 is a block diagram of an alternative example embodiment in the form of a gate 1200 used in a transit system. These various blocks may be implemented in hardware, firmware, or software. Further, these various blocks are logically or physically connected. Shown are a processor 1201 and a memory 1202 that is operatively connected to the processor 1201. Memory 1202 may be persistent or non-persistent memory. Operatively connected to the processor 1201 is a reader 1203 to receive a digital certificate associated with an account managed by a financial institution, the account to be accessed to pay for an ultra-low latency transaction. In some example embodiments, the processor 1201 verifies the validness that includes information relating to the account managed by the financial institution. Operatively connected to the processor 1201 is a mechanism 1204 to authorize completion of the ultra-low latency transaction based upon the verified data. This mechanism 1204 may be a gate, a device to remove a physical barrier to allow entry a transit system, unlocking a door, or delivering an item such as a ticket. In some example embodiments, the reader 1203 receives the digital certificate. In some example embodiments, the processor 1201 generates a further digital certificate through the use of the digital certificate, a transit server identifier, and a gate identifier. Operatively connected to the processor 1201 is a writer 1205 to write the further digital certificate to a device. In some example embodiments, the reader 1203 receives a further digital certificate generated, in part, based upon the digital certificate, a transit server identifier, and a gate identifier. In some example embodiments, the processor 1201 generates an added digital certificate through the use of the digital certificate, the transit server identifier, the gate identifier, and a transaction identifier. A writer 1206 is operatively connected to the processor 1201 to write the added digital certificate to a device.

In some example embodiments, the reader 1203 receives a further digital certificate generated, in part, based upon the digital certificate, an account data associated with the account managed by the financial institution, a transit server identifier, and a nonce. In some example embodiments, the processor 1201 generates an added digital certificate generated, in part, through a use of the transit server identifier, the further digital certificate, a transaction identifier, and a gate identifier. Operatively connected to the processor 1201 is a writer 1207 to write the added digital certificate to a device. In some example embodiments, an additional reader 1208 is shown to receive another digital certificate generated, in part, through the use of the account number, the added digital certificate, and another nonce. Operatively connected to the additional reader 1208 is a processor 1209 to generate a final digital certificate generated, in part, through a use of the digital certificate, the transit server identifier, and the gate identifier. Operatively connected to the processor 1209 is an additional writer 1210 to write the final digital certificate to a device. In some example embodiments, the processor 1201 and 1209 are operatively connected via the network 108.

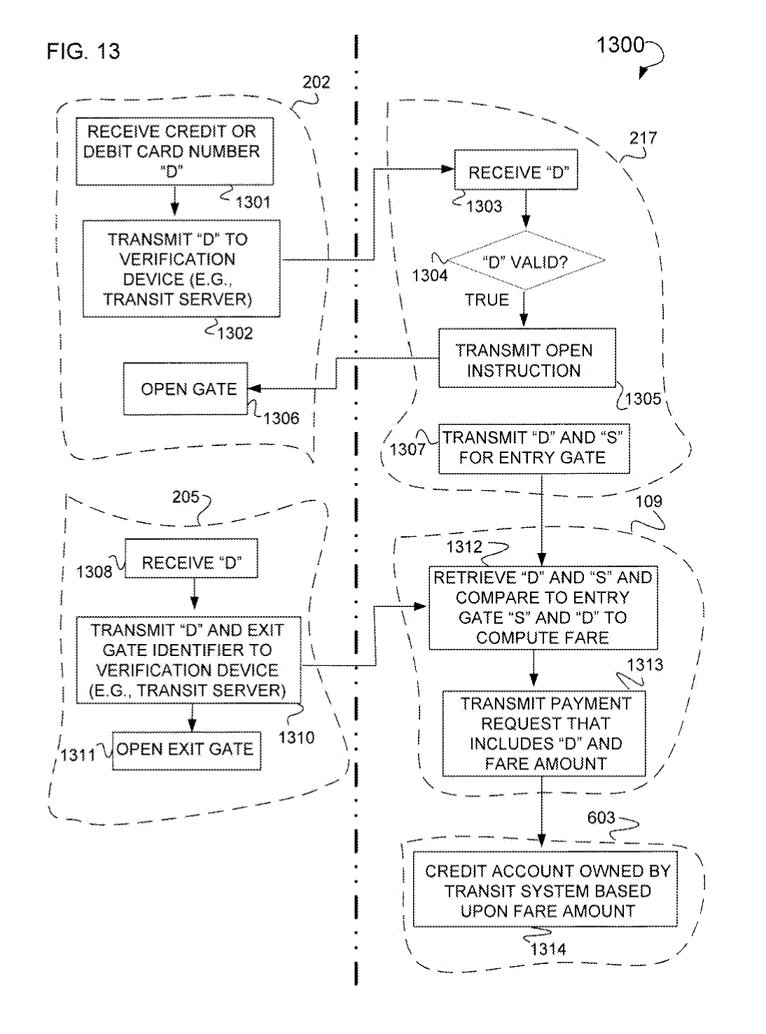

FIG. 13 is a dual-stream flow chart illustrating an alternative example embodiment in the form of a method 1300 that regulates the usage of a transit system through comparing account data “D” against a white list. The corresponding protocol is illustrated in FIG. 2. Shown is a first stream that includes operations 1301-1302, and 1306. These various operations may be performed by the entry gate 202. Additionally shown in this first stream are operations 1308-1311 executed by the exit gate 205. Shown is a second stream that includes operations 1303-1305, and 1307. These various operations may be executed by the station server 217, or transit server 109. Also shown are operations 1312-1313 that are executed by the transit server 109. Further, shown is an operation 1314 that is executed by the funds verifier server 603. Operation 1301 is executed to receive a credit or debit card account data “D.” An operation 1302 is executed to transmit “D” to a verification device such as the transit server 109, or station server 217. Operation 1303 is executed to receive the “D” value. A decisional operation 1304 is executed to determine whether the “D” value is valid. In cases where decisional operation 1304 evaluates to “true,” operation 1305 is executed. In cases where decisional operation 1304 evaluates to “false,” an error signal is generated. Operation 1305 is executed to transmit an open instruction to the entry gate 202. Operation 1306 is executed to open the entry gate 202. Operation 1307, when executed, transmits “D” and an entry gate identifier (i.e., “S”) to a verification device (e.g., transit server 109). Operation 1308 is executed to receive “D” from a device 107 at the exit gate 205.

In some example embodiments, operation 1310 is executed to transmit “D” and a gate identifier (i.e., “S₁”) to the transit server 109. Operation 1311 is executed to open the exit gate 205. Operation 1312 is executed to retrieve the “D” and “S” values supplied by the entry gate 202 via the station server 217, and to compare these values to the “D” and “S₁” values received from the exit gate 205. Where the values match, a fare may be calculated based upon, for example, the difference in geographical distance between the entry gate 202 and the exit gate 205. Operation 1313 is executed to transmit a payment request to the funds verifier server 603. (See FIG. 9.) Operation 1314 is executed to credit the account owned by the transit system based upon the fare amount and debit the rider's account by the corresponding amount.

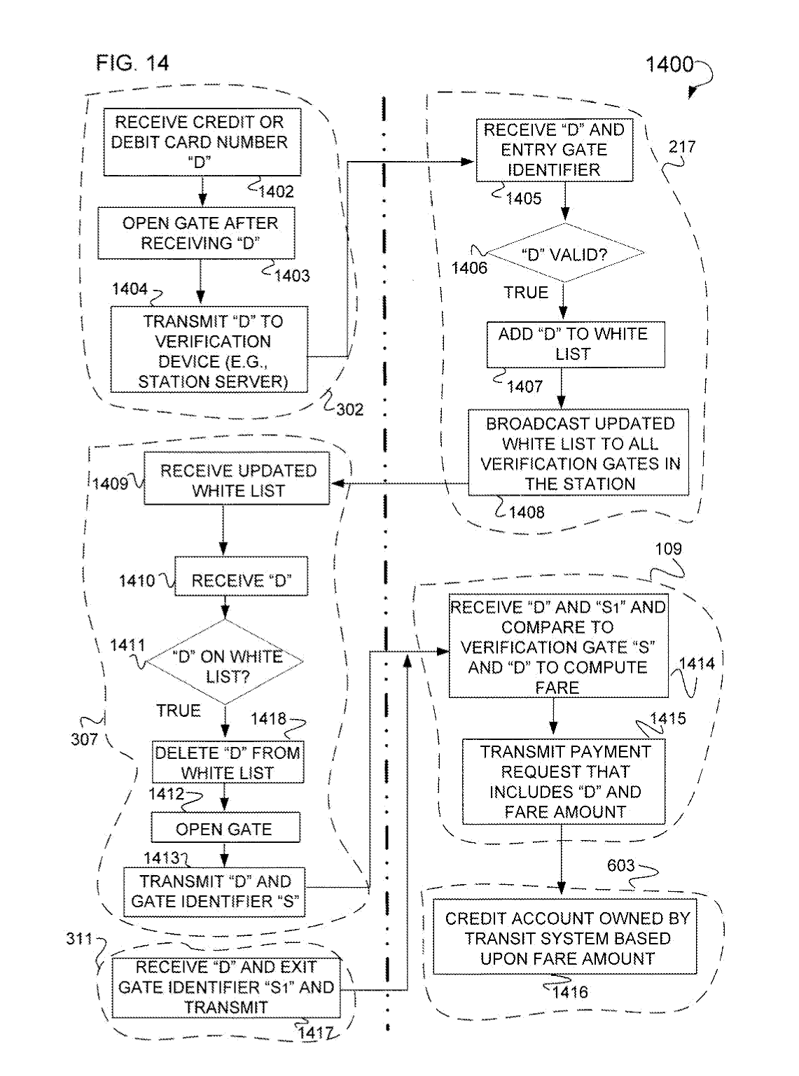

FIG. 14 is a dual-stream flow chart illustrating an alternative example embodiment in the form of a method 1400 that regulates the usage of a transit system through comparing “D” against a white list that resides locally (i.e., within the gates or station server in a specific location) within the transit system. Shown is a first stream that includes operations 1402-1404 that are executed by the gate 302. Also shown are operations 1409-1413, and 1418, executed by gate 307. An operation 1417 is executed by the gate 311. Additionally illustrated, are operations 1405-1408 executed by the station server 217. Operations 1414-1415 are shown that are executed by the transit server 109. Operation 1416 is shown that is executed by the fund verifier server 603. The corresponding protocol is illustrated in FIG. 3. Operation 1402 is executed that receives a credit or debit card account data (i.e., “D”). Operation 1403 is executed that opens the entry gate 302 after “D” is received. An operation 1404 is executed that transmits “D” to a verification device such as the station server 217. Operation 1405 is executed to receive the “D” value. A decisional operation 1406 is executed to determine whether the “D” value is valid. In some example embodiments, through the execution of decisional operation 1406, “D” is sent to the funds verifier server 603, or other suitable server controller by a financial institution, to determine whether “D” is valid. Where “D” is valid, the funds verifier server 603 returns a “true” value, where “D” is invalid the funds verifier server returns “false” value. In cases where a “true” value is returned, the decisional operation 1406 evaluates to “true” and operation 1407 is executed. In cases where a “false” value is returned the decisional operation 1406 evaluates to “false” and an error signal is generated. Operation 1407 is executed to add “D” to a white list. Operation 1408 is executed to broadcast an updated white list that includes “D” to all verification gates in the station. Operation 1409 is executed to receive an update white list.

In some example embodiments, operation 1410 is executed to receive “D.” Decisional operation 1411 is illustrated that determines whether “D” is on the updated white list. In cases where decisional operation 1411 evaluates to “false” an error signal is generated. In cases where decisional operation 1411 evaluates to “true,” an operation 1418 is executed to delete “D” from the white list on some or all of the verification gates in the transportation station that includes the gates 302 and 307. Operation 1412 is executed to open the gate 302. Operation 1413 is executed to transmit “D” and the gate identifier “S” to the transit server 109. Operation 1417 is executed to receive the “D” value and to transmit this “D” value and a gate identifier “S1.” Operation 1414 is executed to receive “D” and “S₁” from the exit gate 311, and to compare the “D,” and the “S” and “S₁” values to compute a fare for riding the transit system in some embodiments. This fare may be computed based upon, for example, the geographical distance between the gate 307 and gate 311. Operation 1415 is executed to transmit a payment request to the funds verifier server 603. Operation 1416 is executed to credit the account owned by the transit system based upon the fare amount and debit the rider's account by the corresponding amount. A transaction fee may be applied through the execution of operation 1416.

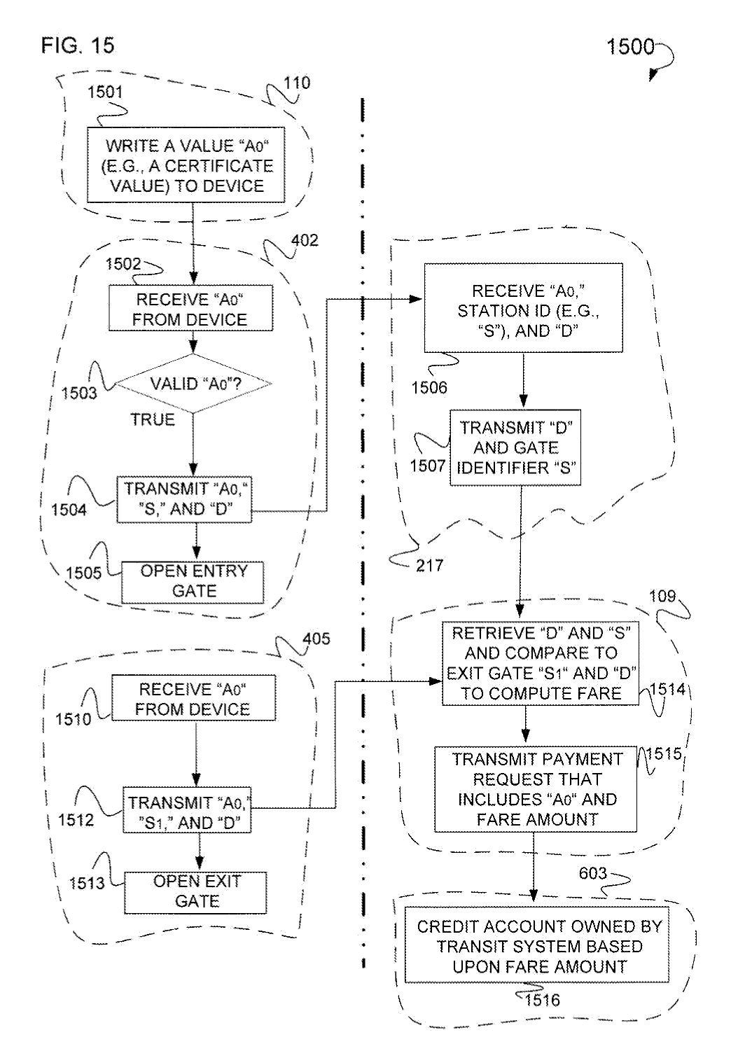

FIG. 15 is a dual-stream flow chart illustrating an example method 1500 that uses a digital certificate in combination with writable memory on a credit or debit card to validate account data “D.” Shown is a first stream that includes operations 1501, 1502-1505 and 1510, and 1512-1513. Operation 1501 is executed on behalf of the financial institution, perhaps using one or more of the devices 110. Operations 1502-1505, and 1510 and 1512-1513 may be executed by the gate 402 and gate 405 respectively. Also shown are operations 1506-1507, and 1514-1515, and 1516. Operations 1506-1507 may be executed by the station server 217. Operations 1514-1515 may be executed by the transit server 109. Operation 1516 may be executed by the funds verifier server 603. In some example embodiments, operation 1501 is executed that writes the “A₀” value to a device. (See FIG. 1.) Operation 1502 is executed that receives “A₀” from a device. (See FIG. 4.) A decisional operation 1503 is executed that determines whether “A₀” is valid. In cases where the decisional operation 1503 evaluates to “true,” operation 1504 is executed. In cases where decisional operation 1503 evaluates to “false,” an error signal is generated. Operation 1504, when executed, transmits “A₀,” “S,” and “D” to the station server 217, and operation 1506 residing thereon. Operation 1505 is executed to open gate 402. Operation 1506 is executed to receive “A₀,” “S,” and “D.” Operation 1507 is executed to transmit “D” and “S” to the transit server 109. Operation 1510 is executed to receive “A₀” from a device. Operation 1512 transmits “A₀,” “S₁,” and “D” to the transit server 109. “A₀,” “S₁,” and “D” are received through the execution of operation 1514. Further, operation 1514 compares the initial “A₀,” “S,” and “D” values stored at operation 1509 to these “A₀,” “S₁,” and “D” received at operation 1514. Based upon this comparison, a fare for using the transit system is computed in some embodiments. This fare is based upon, for example, the geographical distance between the gate 402 and the gate 405, the geographical distance defined in terms of number of stops along the route of the transit system. Operation 1515 is executed to that transmits a payment request that includes “A₀” and a fare amount determined through the execution of operation 1514. This payment request is transmitted by the transit server 109 to be received by the funds verifier server 603. Operation 1516 is executed that credits an account owned by the transit system based upon the amount and debit the rider's account by the corresponding amount.

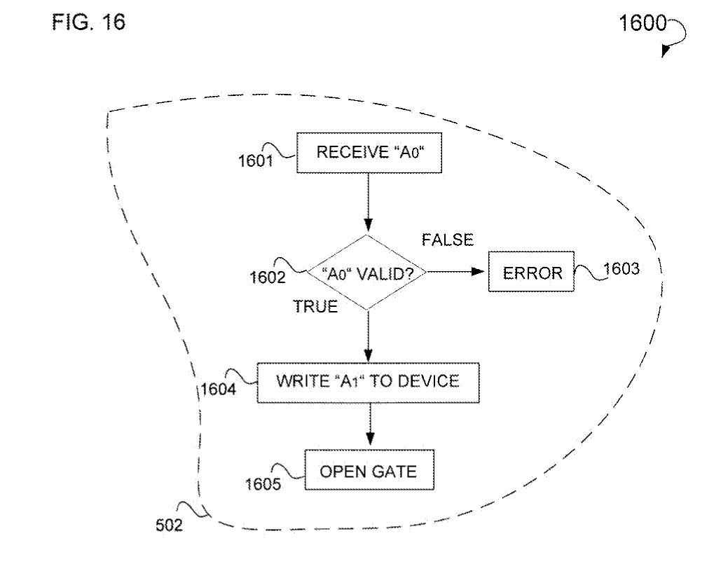

FIG. 16 is a flowchart illustrating an alternative example embodiment in the form of a method 1600 showing the writing of a digital certificate to the device 107. The corresponding protocol is illustrated in FIG. 5. These various operations 1601-1605 may be executed by the gate 502. Shown is an operation 1601 that receives an “A₀” value. A decisional operation 1602 is executed that determines whether the “A₀” is valid. In cases where decisional operation 1602 evaluates to “false,” an error signal is generated via operation 1603. In cases where decisional operation 1602 evaluates to “true,” an operation 1604 is executed. Operation 1604 is executed to write the previously defined “A₁” value to the device 107. The operation 1605 is executed to open the gate 502 after the “A₁” value is written to the device 107. The rider 101 may then be allowed to access the transportation mode 213. In some example embodiments, the “A₁” value is transferred to the transit server 109 so as to verify the “A₁” value. The method illustrated herein may also be used to write “A₄” in FIG. 7 and “A₆” in FIG. 8 to a device.

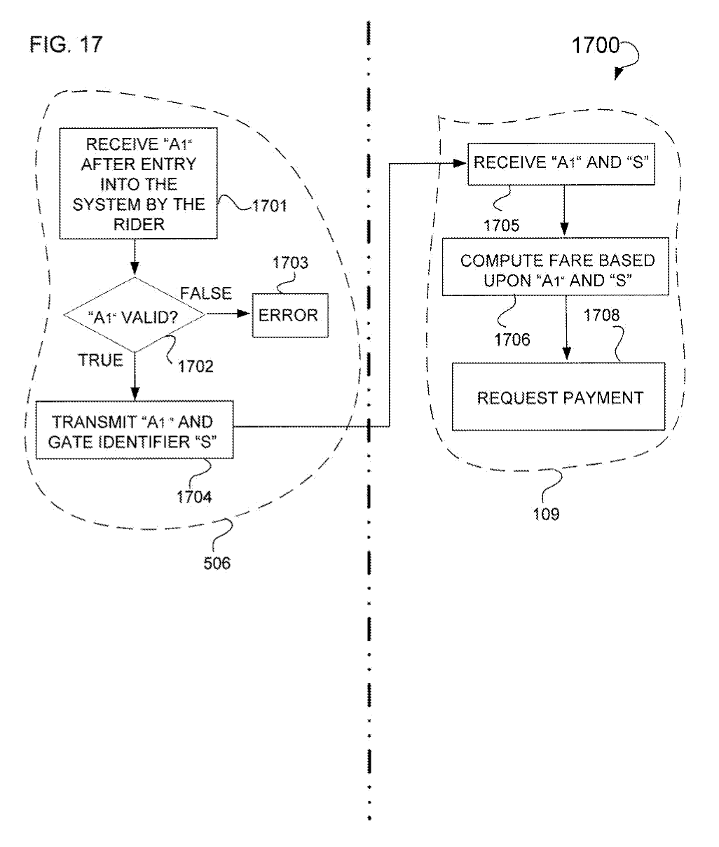

FIG. 17 is a dual-stream flow chart illustrating example method 1700 used to exit a transit system and to request payment for a fare through the use of a digital certificate written to the device 107. The corresponding protocol is illustrated in FIG. 5. Shown are operations 1701-1704 that may be executed by gate 506. Also shown are operations 1705-1706 and 1708 that are executed by a transit server 109. Operation 1701 is executed to receive the “A₁” value. A decisional operation 1702 is executed to determine whether “A₁” is valid. In cases where decisional operation 1702 evaluates to “false,” an error signal is generated via operation 1703. In cases where decisional operation 1702 evaluates to “true,” an operation 1704 is executed. Operation 1704, when executed, transmits “A₁” and a gate identifier “S₁” to the transit server 109. Operation 1705 is executed that receives “A₁” and “S₁” from the gate 506. This “S₁” value identifies the exit gate 506 so as to allow in some embodiments for the correct fare to be determined based upon, for example, the geographical distance travelled from the entry gate 502 and the exit gate 506 via the transportation mode 213. Operation 1706 is executed that computes a fare based upon the “A₁” and “S₁” values. An operation 1708 is executed that requests payment from a funds verifier server 603.

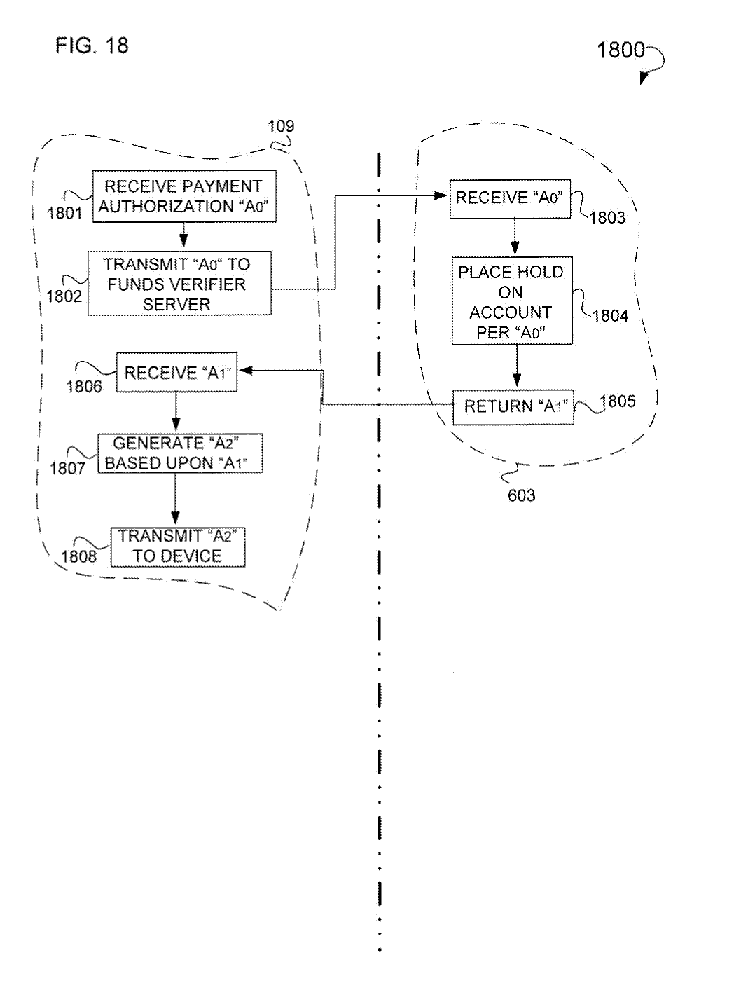

FIG. 18 is a dual-stream flow chart illustrating an alternative example embodiment in the form of a method 1800 to place a hold on a portion of an account used to pay a fare for a rider of a transit system. The corresponding protocol is illustrated in FIG. 6. The account may be a credit or debit card account. Shown are operations 1801-1802, and 1806-1808. These operations may be executed by the transit server 109. Also shown are operations 1803-1805 that may be executed by the funds verifier server 603. Operation 1801 is executed to receive a payment authorization that includes “A₀.” This “A₀” value is received from the device 107. An operation 1802 is executed that transmits “A₀” to the funds verifier server 603. An operation 1803 is executed receive the “A₀” value. An operation 1804 is executed to place a hold on an account identified via the “A₀” value. This account is rider 101's credit or debit card account. Operation 1805 is executed to return an “A₁” value to the requesting transit server 109. Operation 1806 is executed to receive the “A₁” value. Operation 1807 is executed to generate an “A₂” value based upon the “A₁” value, as previously shown in FIG. 6. Operation 1808 is executed to transmit “A₂” to the device 107.

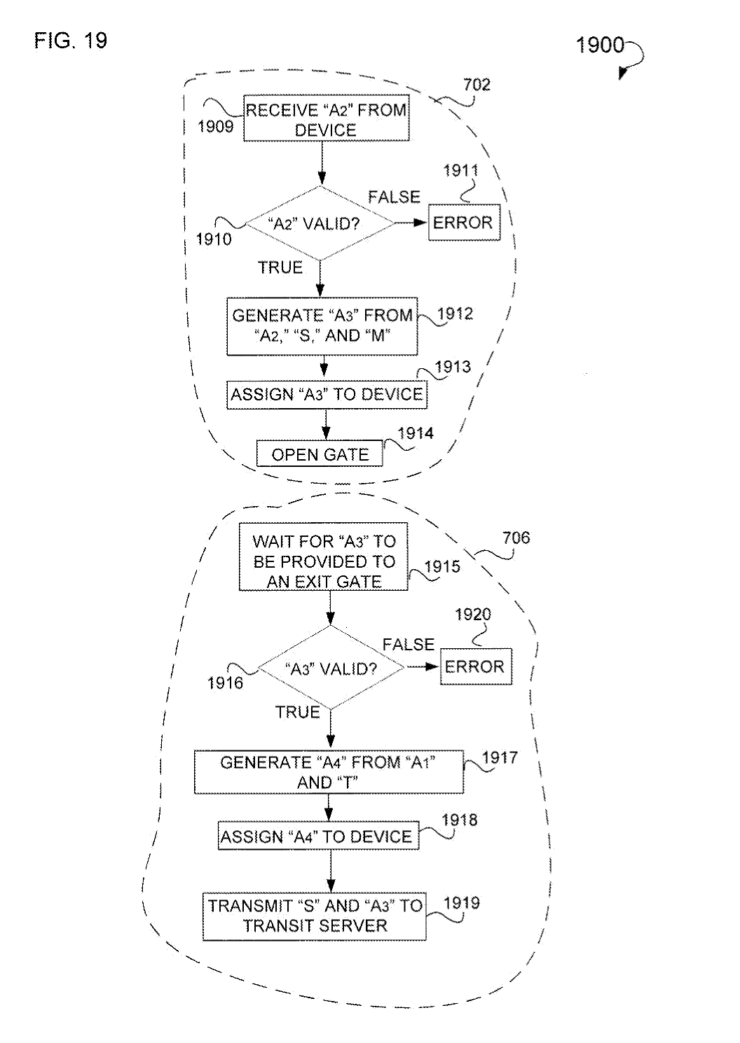

FIG. 19 is a flowchart illustrating an alternative example embodiment in the form of a method 1900 showing the writing of a digital certificate to the device 107 used in accessing a gate. The corresponding protocol is described in FIG. 7. Operations 1909-1914 are executed by the gate 702. Operations 1915-1918 are executed by the gate 706. Operation 1909 executed to receive the “A₂” value from the device 107. A decisional operation 1910 is executed to determine whether “A₂” is valid. In cases where decisional operation 1910 evaluates to “false,” an operation 1911 is executed to generate an error signal. In cases where decisional operation 1910 evaluates to “true,” operation 1912 is executed. Operation 1912 is executed to generate an “A₃” value from the previously defined “S” and “M” values. Operation 1913 is executed to transfer the “A₃” value to the device using the gate 702. Operation 1914 is executed to open the gate 702 and allow the rider 101 to use the transportation mode 213.

In some example embodiments, operations 1915-1918 are executed by the gate 706 as part of the method 1900. Operation 1915 is executed to receive “A₃” from a device as the rider 101 completes his/her use of the transportation mode 213. Decisional operation 1916 is executed to determine the validity of “A₃” through verifying “A₃.” In cases where decisional operation evaluates to “false,” an operation 1920 is executed to generate an error signal. In cases where decisional operation 1916 evaluates to “true,” an operation 1917 is executed. Operation 1917 is executed to generate “A₄” from “A₁” and “T.” Operation 1918 is executed to transfer “A₄” to a device as a digital certificate. The assignment executed through the use of a card writer/encoder associated with the gate 706. Operation 1919 is executed to transmit “A₃” and “S₁” to the transit server 109 to facilitate payment of the fare for rider 101.

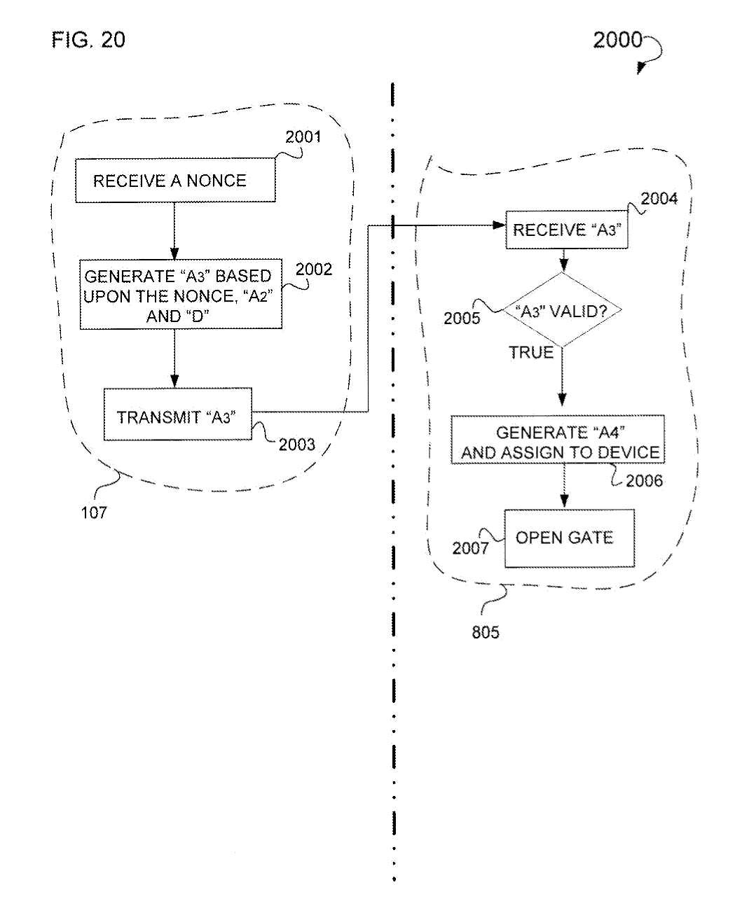

FIG. 20 is a dual-stream flow chart illustrating an alternative example embodiment in the form of a method 2000 that utilizes the writable memory and computing ability of the device 107 in combination with a nonce to access a transit system. The corresponding protocol is illustrated in FIG. 8. Shown are operations 2001-2003. These various operations 2001-2003 may be executed by a device 107. The device 107 may be a credit or debit card with computational capabilities in the form of an embedded smart card chip. Also shown are operations 2004-2007 that may be executed by the gate 805. An operation 2001 is executed that receives a nonce from the gate 805. Operation 2002 is executed to generate “A₃” based upon the nonce “n,” “A₂” and “D.” Operation 2003 is executed to transfer the “A₃” value from the device 107 to the gate 805. Operation 2004 is executed receive the “A₃” value. A decisional operation 2005 is executed to determine whether the “A₃” value is valid. In cases where the decisional operation 2005 evaluates to “true,” an operation 2006 is executed. In cases where the decisional operation 2005 evaluates to “false,” in error signal is generated. Operation 2006 is executed to generate “A₄,” and transfer to the device 107. Operation 2007 is executed to open the gate 805 to enable the rider 101 to use the transportation mode 213.

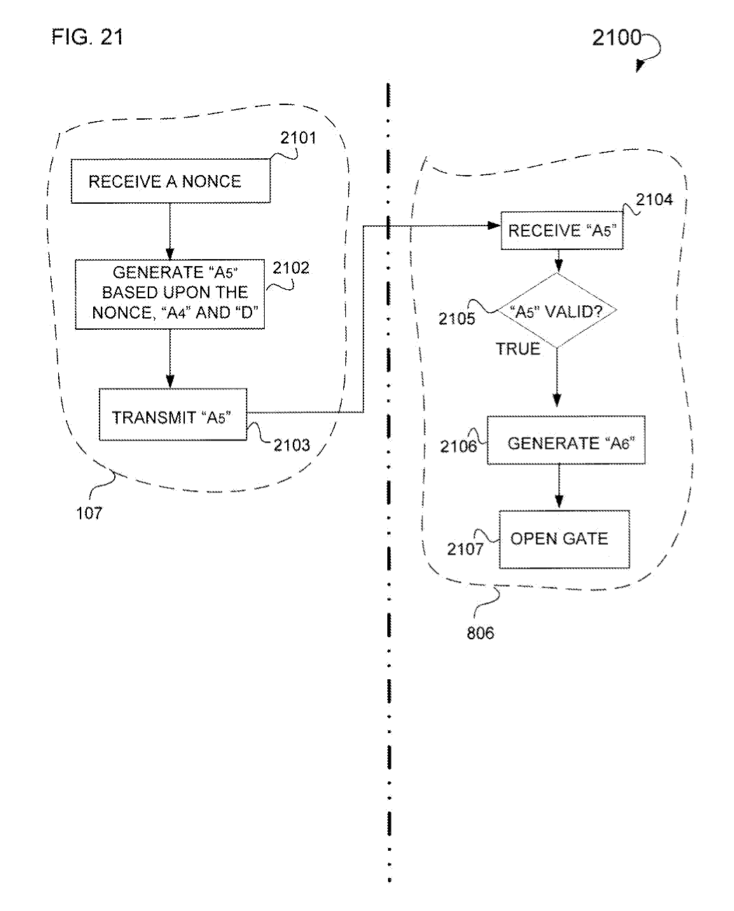

FIG. 21 is a dual-stream flow chart illustrating an alternative example embodiment in the form of a method 2100 that utilizes the writable memory and computing ability of the device 107 in combination with a nonce to exit a transit system. The corresponding protocol is illustrated in FIG. 8. Shown are operations 2101-2103 that are executed on the device 107. The device 107 may be a credit or debit card with computational capabilities in the form of an embedded smart card chip. Also, shown are operations 2104-2107 that are executed by gate 806. In some example embodiments, operation 2101 is executed to receive a nonce “n.” Operation 2102 is executed to generate “A₅” based upon “n,” “A₄,” and “D.” Operation 2103 is executed to transmit the “A₅” value. Operation 2104 is executed receive the “A₅” value. Decisional operation 2105 is executed to determine whether the “A₅” value is valid. In cases where decisional operation 2105 evaluates to “true,” operation 2106 is executed. In cases where decisional operation 2105 evaluates “false,” an error signal is generated. Operation 2107 is executed to open the gate 806 and allow the rider 101 to exit the transit system.

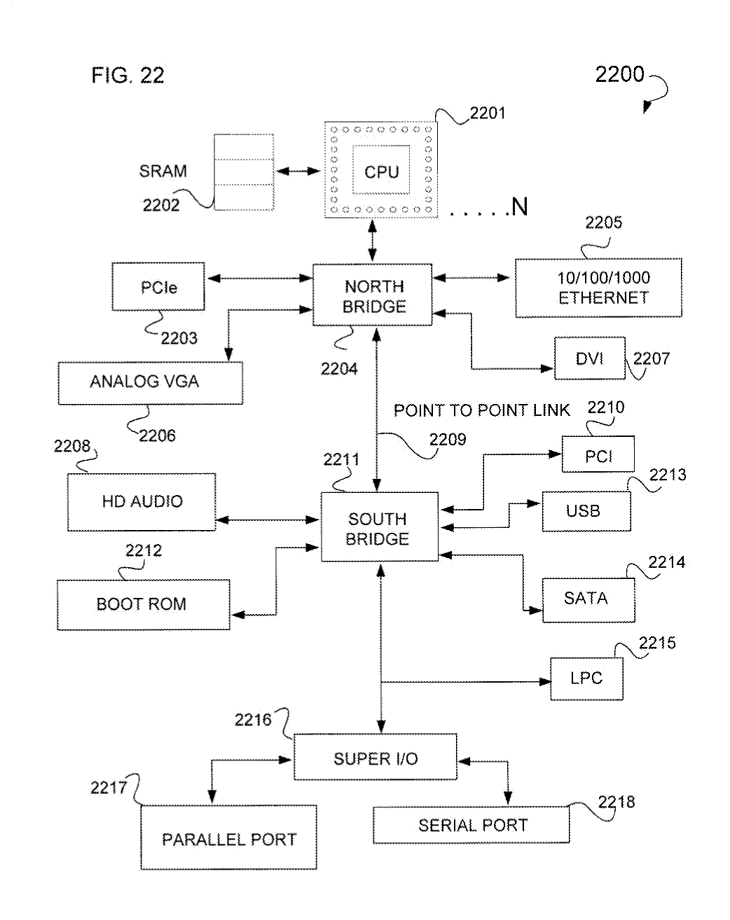

FIG. 22 is a diagram of an example computer system 2200. The processor may be a CPU 2201. In some example embodiments, a plurality of CPU may be implemented on the computer system 2200 in the form of a plurality of core (e.g., a multi-core computer system), or in some other suitable configuration. Some example CPUs include the x86 series CPU. Operatively connected to the CPU 2201 is Static Random Access Memory (SRAM) 2202. Operatively connected includes a physical or logical connection such as, for example, a point to point connection, an optical connection, a bus connection or some other suitable connection. A North Bridge 2204 is shown, also known as a Memory Controller Hub (MCH), or an Integrated Memory Controller (IMC), that handles communication between the CPU and PCIe, Dynamic Random Access Memory (DRAM), and the South Bridge. A PCIe port 2203 is shown that provides a computer expansion port for connection to graphics cards and associated GPUs. An ethernet port 2205 is shown that is operatively connected to the North Bridge 2204. A Digital Visual Interface (DVI) port 2207 is shown that is operatively connected to the North Bridge 2204. Additionally, an analog Video Graphics Array (VGA) port 2206 is shown that is operatively connected to the North Bridge 2204. Connecting the North Bridge 2204 and the South Bridge 2211 is a point to point link 2209. In some example embodiments, the point to point link 2209 is replaced with one of the above referenced physical or logical connections. A South Bridge 2211, also known as an I/O Controller Hub (ICH) or a Platform Controller Hub (PCH), is also illustrated. Operatively connected to the South Bridge 2211 are a High Definition (HD) audio port 2208, boot RAM port 2212, PCI port 2210, Universal Serial Bus (USB) port 2213, a port for a Serial Advanced Technology Attachment (SATA) 2214, and a port for a Low Pin Count (LPC) bus 2215. Operatively connected to the South Bridge 2211 is a Super Input/Output (I/O) controller 2216 to provide an interface for low-bandwidth devices (e.g., keyboard, mouse, serial ports, parallel ports, disk controllers). Operatively connected to the Super I/O controller 2216 is a parallel port 2217, and a serial port 2218.

The SATA port 2214 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 2202 and/or within the CPU 2201 during execution thereof by the computer system 2200. The instructions may further be transmitted or received over the 10/100/1000 ethernet port 2205, USB port 2213 or some other suitable port illustrated herein.

In some example embodiments, a removable physical storage medium is shown to be a single medium, and the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

The various methods illustrated herein may be implemented as data and instructions (of the software) that are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations there from. It is intended that the appended claims cover such modifications and variations as fall within the “true” spirit and scope of the invention.

What is claimed is:

1. A system comprising:
a reader to receive account data associated with an account managed by a financial institution, the account to be accessed to pay an amount associated with an ultra-low latency transaction;
a receiver to receive an instruction authorizing completion of the ultra-low latency transaction, the instruction generated based upon a comparison of the account data to an entry in a list that includes a plurality of account data; and
a mechanism to allow completion of the ultra-low latency transaction.

2. The system of claim 1, wherein the reader is at least one of a magnetic stripe reader, a Radio Frequency Identifier (RFID) tag reader, or a reader that is capable of reading a microchip storage on a portable device.

3. The system of claim 1, wherein the account data includes at least one of a credit card account number, a debit card account number, an account holder name associated with an account number, or an expiration date associated with an account number.

4. The system of claim 3, wherein the account data is registered with the system before it is received by the reader.

5. The system of claim 1, further comprising:
an additional reader to receive the account data associated with the account managed by the financial institution;
a processor to compare the account data to the entry in the list that includes the plurality of account information; and
a transmitter to transmit the account data and an identifier, the identifier to identify a mechanism used to complete the ultra-low latency transaction.

6. The system of claim 5, wherein the reader, the receiver, and the entry mechanism reside on an entry gate of a transit system, and the additional reader, the processor, and the transmitter reside on an exit gate of the transit system.

7. A system comprising:
a reader to receive an account data associated with an account managed by a financial institution, the account to be accessed to pay for an ultra-low latency transaction;
a processor to compare the account data to an entry in a list that includes account data;
a deletion module to delete an entry in the list, the entry deleted based upon the comparison of the account data to the entry in the list that includes account data; and
a mechanism to authorize completion of the ultra-low latency transaction based upon the comparison of the account data and the entry in the list.

8. The system of claim 7, further comprising:
an additional reader to receive the account data associated with the account managed by the financial institution; and
a transmitter to transmit the account data and an identifier, the identifier to identify an exit mechanism used to complete the ultra-low latency transaction.

9. The system of claim 7, wherein the list is a white list.

10. The system of claim 7, wherein the reader, the processor, the deletion module, and access mechanism reside on a first gate, and the additional reader and the transmitter reside on a second gate of a transit system.

11. A system comprising:
a reader to receive a digital certificate associated with an account managed by a financial institution, the account to be accessed to pay for an ultra-low latency transaction;
a processor to verify data relating to the account managed by the financial institution; and
an access mechanism to authorize completion of the ultra-low latency transaction based upon the verified data.

12. The system of claim 11, wherein:
the reader receives the digital certificate;
the processor generates a further digital certificate through the use of the digital certificate, a transit server identifier, and a gate identifier; and
a writer to write the further digital certificate to a device.

13. The system of claim 11, wherein:
the reader receives a further digital certificate generated, in part, based upon the digital certificate, a transit server identifier, and a gate identifier;
the processor generates an added digital certificate through the use of the digital certificate, the transit server identifier, the gate identifier, and a transaction identifier; and
a writer to write the added digital certificate to a device.

14. The system of claim 11, wherein:
the reader receives a further digital certificate generated, in part, based upon the digital certificate, an account data associated with the account managed by the financial institution, a transit server identifier, and a nonce;
the processor generates an added digital certificate generated, in part, through a use of the transit server identifier, the further digital certificate, a transaction identifier, and a gate identifier; and
a writer to write the added digital certificate to a device.

15. The system of claim 14, further comprising:
an additional reader to receive another digital certificate generated, in part, through the use of the account number, the added digital certificate, and another nonce;
an additional processor to generate a final digital certificate generated, in part, through a use of the digital certificate, the transit server identifier, and the gate identifier; and
an additional writer to write the final digital certificate to a device.
